(19) United States
(12) Patent Application Publication
(10) Pub. No.: US 2021/0305803 A1
(43) Pub. Date: Sep. 30, 2021

(54) LEAKAGE PROTECTION SWITCH

(71) Applicant: KEDU ELECTRIC CO., LTD., Wenzhou (CN)

(72) Inventors: Chunkai ZHENG, Wenzhou (CN); Yingxian LI, Wenzhou (CN)

(21) Appl. No.: 17/344,904

(22) Filed: Jun. 10, 2021

(30) Foreign Application Priority Data
Dec. 10, 2020 (CN) 202022995729.0
Dec. 10, 2020 (CN) 202022995797.7

(51) Int. Cl. H02H 3/16; H01H 47/22; H01H 47/00; H01H 50/44

(52) U.S. Cl. CPC H02H 3/16; H01H 50/44; H01H 47/002; H01H 47/22

(57) ABSTRACT

A leakage protection switch. Control ends of a first drive submodule and a second drive submodule are connected to a microcontroller, and output ends of the two drive submodules are connected to a coil attract module. After the microcontroller sends out a trip signal, the action of the coil attract module is controlled by the two drive submodules, which reduces the occurrence of failure action and improves the control reliability of the leakage protection switch.

### CROSS-REFERENCE TO RELATED APPLICATIONS

This application claims the benefit of priority from Chinese Patent Application Nos. 202022995797.7 and 202022995729.0, both filed on Dec. 10, 2020. The content of the aforementioned application, including any intervening amendments thereto, is incorporated herein by reference in its entirety.

### TECHNICAL FIELD

The present application relates to leakage protection, and more particularly to a leakage protection switch.

### BACKGROUND

The increasing popularity of household appliances has brought a lot of convenience to our lives, also accompanied by some potential dangers. For example, as the occurrence of electric leakage, overload or short circuit will not only easily damage the electrical appliances, but also even cause electrical fires and endanger personal safety. As a device for protecting the power distribution system, the leakage protection device can quickly cut off the power supply when an electric leakage occurs, improving the safety and avoiding unnecessary loss. Unfortunately, the existing leakage protection devices struggle with single function and thus fail to provide a full range of protection.

### SUMMARY

In order to overcome the defect of the single function of the leakage protection device in the prior art, the present disclosure provides a leakage protection switch.

The technical solutions of the present disclosure are described as follows.

The present disclosure provides a leakage protection switch, comprising:

a current mutual inductance module;

a leakage protection circuit;

a microcontroller;

a solenoid drive module;

a coil attract module; and

a test module;

wherein an input end of the current mutual inductance module is connected to a circuit to be tested; an output end of the current mutual inductance module is connected to an input end of the leakage protection circuit; the current mutual inductance module is configured to detect a residual current signal of the circuit to be tested and send the residual current signal to the leakage protection circuit;

an output end of the leakage protection circuit is connected to an input end of the microcontroller; the leakage protection circuit is configured to receive the residual current signal and determine whether the residual current signal is greater than a set threshold; if the residual current signal is greater than the set threshold, a leakage signal is generated by the leakage protection circuit and sent to the microcontroller;

output ends of the microcontroller are connected to an input end of the solenoid drive module; the microcontroller is configured to generate a trip signal according to the leakage signal and send the trip signal to the solenoid drive module; an output end of the solenoid drive module is connected to one end of the coil attract module; the solenoid drive module is configured to control the coil attract module to trip according to the trip signal, thereby cutting off the circuit to be tested; the solenoid drive module comprises a first drive submodule and a second drive submodule; the output ends of the microcontroller comprises a first output end and a second output end; the first output end of the microcontroller is connected to a control end of the first drive submodule; the second output end of the microcontroller is connected to a control end of the second drive submodule; an output end of the first drive submodule and an output end of the second drive submodule are both connected to the coil attract module;

one end of the test module is connected to the circuit to be tested, and the other end of the test module is connected to the current mutual inductance module; and the test module is configured to test the leakage protection switch.

In some embodiments, the coil attract module comprises a solenoid and a first capacitor; one end of the solenoid is connected to the output end of the first drive submodule, and the other end of the solenoid is connected to one end of the first capacitor and the output end of the second drive submodule, and then connected to a first external power supply; and the other end of the first capacitor is connected to ground.

In some embodiments, the first drive submodule comprises a first controllable switch; a first end of the first controllable switch is connected to one end of the solenoid; a control end of the first controllable switch is connected to the first output end of the microcontroller; and a second end of the first controllable switch is connected to the ground.

In some embodiments, the second drive submodule comprises a second controllable switch and a first resistor; a first end of the second controllable switch is connected to one end of the first resistor; a control end of the second controllable switch is connected to the second output end of the microcontroller; and a second end of the second controllable switch is connected to the ground;

the other end of the first resistor is respectively connected to the end of the first capacitor connected to the solenoid and the end of the solenoid connected to the first capacitor.

In some embodiments, the second drive submodule further comprises a third controllable switch and a second resistor;

wherein a first end of the third controllable switch is respectively connected to one end of the second resistor and the control end of the second controllable switch; a control end of the third controllable switch is connected to the second output end of the microcontroller; a second end of the third controllable switch is connected to the ground; and the other end of the second resistor is connected to a second external power supply.

In some embodiments, the leakage protection switch further comprises a first power supply module; wherein an input end of the first power supply module is connected to the circuit to be tested; an output end of the first power supply module is respectively connected to the leakage protection circuit and the microcontroller; and the first power supply module is configured to supply power to the leakage protection circuit and the microcontroller.

In some embodiments, the leakage protection switch further comprises a second power supply module; wherein an input end of the second power supply module is connected to the circuit to be tested; an output end of the second power supply module is respectively connected to the solenoid drive module and the coil attract module; and the second power supply module is configured to supply power to the solenoid drive module and the coil attract module.

In some embodiments, the leakage protection switch further comprises a voltage sampling module; wherein an input end of the voltage sampling module is connected to the second power supply module; an output end of the voltage sampling module is connected to the microcontroller; and the voltage sampling module is configured to collect a power supply voltage signal of the second power supply module.

In some embodiments, the leakage protection switch further comprises a self-test module; wherein an input end of the self-test module is connected to the microcontroller; an output end of the self-test module is connected to the current mutual inductance module; and the self-test module is configured to self-test the leakage protection switch.

In some embodiments, the test module comprises a variable resistor and a test button, and the variable resistor is connected to the test button.

In some embodiments, the leakage protection switch further comprises a reset button; wherein the reset button is connected to the microcontroller, and the reset button is configured to reset the leakage protection switch.

In some embodiments, the leakage protection switch further comprises an alarm indicator; wherein the alarm indicator is connected to the microcontroller, and the alarm indicator is configured to work when a failure occurs to the leakage protection switch.

Compared to the prior art, the present disclosure has the following beneficial effects.

The leakage protection switch provided in the present disclosure includes a current mutual inductance module, a leakage protection circuit, a microcontroller, a solenoid drive module, a coil attract module and a test module. An input end of the current mutual inductance module is connected to a circuit to be tested, and an output end of the current mutual inductance module is connected to an input end of the leakage protection circuit. The current mutual inductance module is configured to detect a residual current signal of the circuit to be tested, and send the residual current signal to the leakage protection circuit. An output end of the leakage protection circuit is connected to an input end of the microcontroller, and the leakage protection circuit is configured to for receive the residual current signal and determining whether the residual current signal is greater than a set threshold. If the residual current signal is greater than the set threshold, a leakage signal is generated by the leakage protection circuit and sent to the microcontroller. Output ends of the microcontroller are connected to an input end of the solenoid drive module, and the microcontroller is configured to generate a trip signal according to the leakage signal, and send the trip signal to the solenoid drive module. An output end of the solenoid drive module are connected to one end of the coil attract module, and the solenoid drive module is configured to control the coil attract module to trip according to the trip signal, thereby cutting off the circuit to be tested. The solenoid drive module includes a first drive submodule and a second drive submodule, and the output ends of the microcontroller include a first output end and a second output end. The first output end of the microcontroller is connected to a control end of the first drive submodule, and the second output end of the microcontroller is connected to a control end of the second drive submodule. An output end of the first drive submodule and an output end of the second drive submodule are both connected to the coil attract module. One end of the test module is connected to the circuit to be tested, and the other end of the test module is connected to the current mutual inductance module. The test module is configured to test the leakage protection switch.

The control ends of the first drive submodule and second drive submodule are connected to the microcontroller, and the output ends of the first drive submodule and second drive submodule are connected to the coil extract module. After the microcontroller sends a trip signal, the two drive submodules synergistically control the action of the coil attract module, thereby reducing the probability of failure action and improving the control reliability of the leakage protection switch. Before the normal operation, the residual current is generated by the test module to determine whether the leakage protection switch can be tripped normally. If the circuit is detected to be cut off, it is indicated that the leakage protection switch can be tripped normally, otherwise it is indicated that the leakage protection switch cannot be tripped normally, determining whether the leakage protection switch can work normally. Therefore, the leakage protection switch provided herein can provide safe and reliable leakage protection for users.

### BRIEF DESCRIPTION OF THE DRAWINGS

The disclosure will be described below with reference to the accompanying drawings to make the technical solutions of the present disclosure clearer. Obviously, presented in the drawings are only some embodiments of the present disclosure. For those of ordinary skill in the art, other drawings can be obtained based on these drawings without sparing creative effort.

FIG. 1 is a block diagram showing a principle of a leakage protection switch according to an embodiment of the present disclosure.

FIG. 2 is another block diagram showing the principle of the leakage protection switch according to an embodiment of the present disclosure.

FIG. 3 is a circuit diagram of the leakage protection switch according to an embodiment of the present disclosure.

FIG. 4 is another circuit diagram of the leakage protection switch according to an embodiment of the present disclosure.

FIG. 5 is a circuit diagram of a self-test module according to an embodiment of the present disclosure.

1, current mutual inductance module; 2, leakage protection circuit; 3, microcontroller; 4, solenoid drive module; 41, first drive submodule; 42, second drive submodule; 5, coil attract module; 6. test module 7, first power supply module; 8, second power supply module; 9, voltage sampling module; 10, self-test module; 11, alarm indicator; and 12, reset button.

### DETAILED DESCRIPTION OF EMBODIMENTS

The technical solutions of the present disclosure will be described clearly and completely in conjunction with the accompanying drawings and embodiments. Obviously, the described embodiments are merely some embodiments of the present disclosure, and are not intended to limit the disclosure. Based on the embodiments of the present disclosure, all other embodiments obtained by those of ordinary skill in the art without sparing creative effort shall fall within the scope of the present disclosure.

As used herein, it should be noted that the terms “first”, “second”, and “third” are only used for descriptive purposes, and cannot be understood as indicating or implying relative importance.

As used herein, it should be noted that, unless otherwise clearly specified and limited, the terms “arrange”, “connect”, and “joint” should be understood in a broad sense. For example, the term “connect” can be indicated as a fixed connection, a detachable connection or an integral connection, a mechanical connection or an electrical connection, a direct connection or an indirect connection through an intermediate medium, or a communication between interiors of two components, a wireless connection or a wired connection. For those of ordinary skill in the art, the specific meaning of the above-mentioned terms in the present disclosure can be understood under specific circumstances.

In addition, the technical features involved in different embodiments of the present disclosure described below can be combined with each other as long as they do not conflict with each other.

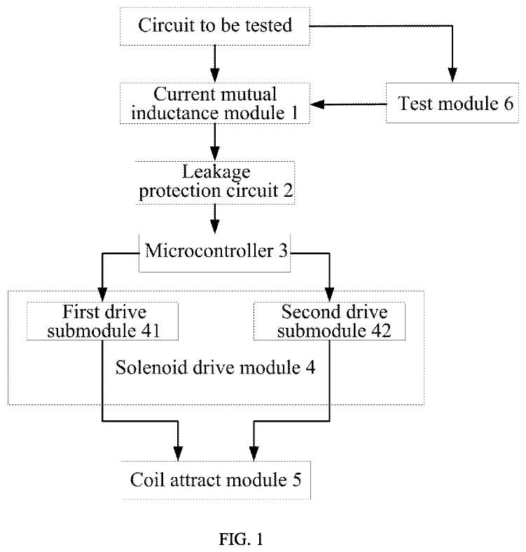

As shown in FIG. 1, an embodiment provides a leakage protection switch for the circuit leakage protection. When an electric leakage occurs, the power supply can be immediately cut off to prevent safety accidents caused by personal electric shock and leakage. The leakage protection switch includes a current mutual inductance module 1, a leakage protection circuit 2, a microcontroller 3, a solenoid drive module 4, a coil attract module 5 and a test module 6, where an input end of the current mutual inductance module 1 is connected to the circuit to be tested, and an output end of is connected to an input end of the leakage protection circuit 2. The current mutual inductance module 1 is configured to detect the residual current signal of the circuit to be tested, and send the residual current signal to the leakage protection circuit 2. An output end of the leakage protection circuit 2 is connected to the input end of the microcontroller 3. The leakage protection circuit 2 is configured to receive and determine whether the residual current signal is greater than a set threshold. If the residual current signal is greater than a set threshold, a leakage signal is generated and sent to the leakage signal to the microcontroller 3. An output end of the microcontroller 3 is connected to the input end of the solenoid drive module 4, and the microcontroller 3 is configured to generate a trip signal and send the trip signal to the solenoid drive module 4. An output end of the solenoid drive module 4 is connected to one end of the coil attract module 5, and the solenoid drive module 4 is configured to control the coil attract module 5 to trip according to the trip signal, so as to cut off the circuit to be tested.

As shown in FIG. 1, in an embodiment, when the current mutual inductance module 1 detects the residual current signal, the residual current is compared with the preset residual current value through an internal comparison circuit of the leakage protection circuit 2. If the current residual current is greater than a preset residual current value, the leakage protection circuit 2 generates a leakage signal and sends the leakage signal to the microcontroller 3. The microcontroller 3 generates a trip signal according to the leakage signal, and the microcontroller 3 sends the trip signal to the solenoid drive module 4. The solenoid drive module 4 controls the coil attract module 5 to trip according to the trip signal, thereby cutting off the circuit to be tested. The processes of the leakage protection circuit 2 generating the leakage signal and the microcontroller 3 generating the trip signal are all the prior art, which will not be repeated herein. As shown in FIG. 1, in an embodiment, the solenoid drive module 4 includes a first drive submodule 41 and a second drive submodule 42. A first output end of the microcontroller 3 is connected to a control end of the first drive submodule 41. A second output end of the microcontroller 3 is connected to the control end of the second drive submodule 42. An output end of the first drive submodule 41 and an output end of the second drive submodule 42 are both connected to the coil attract module 5.

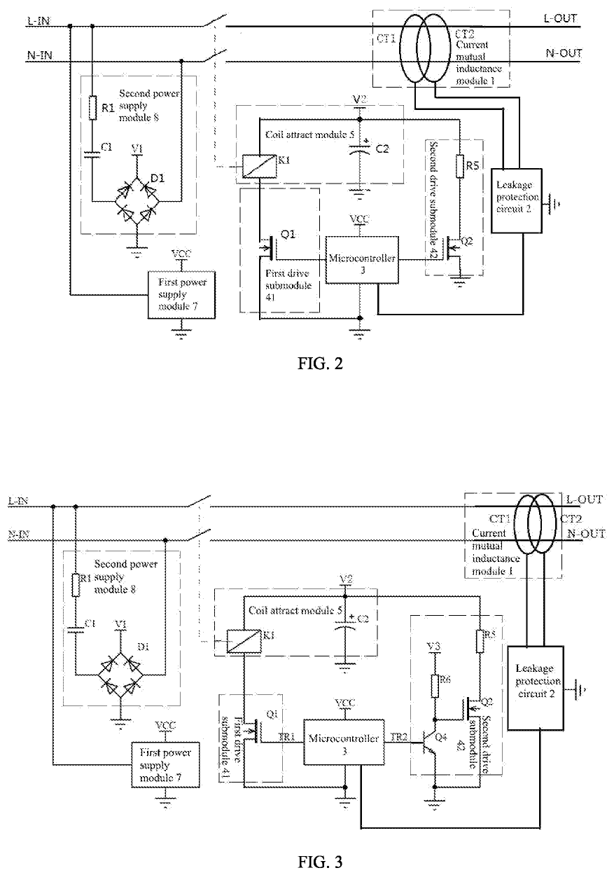

As shown in FIG. 2, in an embodiment, the coil attract module 5 includes a solenoid K1 and a first capacitor C2, where one end of the solenoid K1 is connected to an output end of the first drive submodule 41, and the other end of the solenoid K1 is connected to one end of the first capacitor C2 and an output end of second drive submodule 42, and then connected to the first external power supply V2. The other end of the first capacitor C2 is connected to ground.

As shown in FIG. 2, in an embodiment, the first drive submodule 41 includes a first controllable switch Q1, where a first end of the first controllable switch Q1 is connected to one end of the solenoid K1. A control end of the first controllable switch Q1 is connected to the first output end of the microcontroller 3, and a second end of the first controllable switch Q1 is connected to ground. The second drive submodule 42 includes a second controllable switch Q2 and a first resistor R5, where a first end of the second controllable switch Q2 is connected to one end of the first resistor R5, and a control end of the second controllable switch Q2 is connected to the second output end of the microcontroller 3. A second end of the second controllable switch Q2 is connected to ground. The other end of the first resistor R5 is connected to one end of the first capacitor C2.

As shown in FIG. 2, in an embodiment, the current transformer module 1 includes a first current transformer CT1 and a second current transformer CT2.

As shown in FIG. 2, in an embodiment, when the first current transformer CT1 and the second current transformer CT2 both detect the residual current signal, the microcontroller 3 sends a conduction signal to the first controllable switch Q1, and at the same time sends a cut-off signal to to the second controllable switch Q2, to trigger the first controllable switch Q1 to be turned on and trigger the second controllable switch Q2 to be turned off. At this time, the power supply loop of the solenoid K1 is turned on, and the second power supply module 8 starts to supply power to the solenoid K1. When the solenoid K1 is electrified, the switch on the circuit to be tested can be turned off, thereby connecting the circuit to be tested. When the first current transformer CT1 and the second current transformer CT2 detect the residual current signal, the first current transformer CT1 and the second current transformer CT2 send the detected residual current signal to the leakage protection circuit 2, and then the leakage protection circuit 2 compares the residual current signal with the preset residual current value through the internal comparison circuit. If the residual current signal is greater than the preset residual current value, the leakage protection circuit 2 generates a leakage signal, and sends the leakage signal to the microcontroller 3. The microcontroller 3 generates a trip signal according to the leakage signal, and sends a cut-off signal to the first controllable switch Q1, and at the same time sends a turn-on signal to the second controllable switch Q2, to trigger the first controllable switch Q1 to be turned off and trigger the second controllable switch Q2 to be turned on. The voltage across the first capacitor C2 is discharged to the ground through the first resistor R5 and the second controllable switch Q2, so that the solenoid K1 is tripped due to the loss of voltage, and then the corresponding switch contact of the solenoid K1 is disconnected, thereby cutting off the circuit to be tested. When the first current transformer CT1 and the second current transformer CT2 detect the residual current signal, the microcontroller 3 sends a control command to the first controllable switch Q1 and the second controllable switch Q2 at the same time, to cut off the power supply loop of the solenoid K1, and further cuts off the circuit to be tested, thereby playing a role of leakage protection and reducing the probability of rejection.

As shown in FIG. 3, in an embodiment, the second drive submodule 42 further includes a third controllable switch Q4 and a third resistor R6, where a first end of the third controllable switch Q4 is connected to one end of the third resistor R6 and a control end of the third controllable switch Q2. A control end of the third controllable switch Q4 is connected to the second output end of the microcontroller 3, and a second end of the third controllable switch Q4 is connected to ground. The other end of the third resistor R6 is connected to the second external power supply V3.

As shown in FIG. 3, in an embodiment, when the first current transformer CT1 and the second current transformer CT2 do not detect the residual current signal, the microcontroller 3 sends the turn-on signal to the first controllable switch Q1 and the third controllable switch Q4, to trigger the first controllable switch Q1 and the third controllable switch Q4 to be turned on, and the second controllable switch Q2 is turned off due to a loss of the base bias voltage. At this time, the first drive submodule 41 is turned on, the second drive submodule 42 is turned off, and the second power supply module 8 supplies power to the solenoid K1 through the first drive submodule 41. When the solenoid K1 is electrified, the switch on the circuit to be tested can be turned on, thereby turning on the circuit to be tested. When the first current transformer CT1 and the second current transformer CT2 detect the residual current signal, the first current transformer CT1 and the second current transformer CT2 send the detected residual current signal to the leakage protection circuit 2, and the leakage protection circuit 2 compares the residual current signal with the preset residual current value through the internal comparison circuit. If the residual current signal is greater than a preset residual current value, the leakage protection circuit 2 generates a leakage signal, and sends the leakage signal to the microcontroller 3. The microcontroller 3 generates a trip signal according to the leakage signal, and sends a cut-off signal to the first controllable switch Q1 and the third controllable switch Q4, to trigger the first controllable switch Q1 and the third controllable switch Q4 to be cut off. Since the second external power supply V3 supplies power to the control end of the second controllable switch Q2 through the third resistor R6, the second controllable switch Q2 is triggered to be turned on, and the voltage across the first capacitor C2 is discharged to the ground through the first resistor R5 and the second controllable switch Q2, so that the solenoid K1 is tripped due to the loss of voltage, and then the corresponding switch contact of the solenoid K1 is disconnected, thereby cutting off the circuit to be tested.

In the embodiment, the first controllable switch Q1, the second controllable switch Q2, and the third controllable switch Q4 are insulated gate field effect transistors or triodes.

As shown in FIG. 1, the leakage protection switch further includes a test module 6, where one end of the test module 6 is connected to the circuit to be tested, and the other end of the test module 6 is connected to the current mutual inductance module 1.

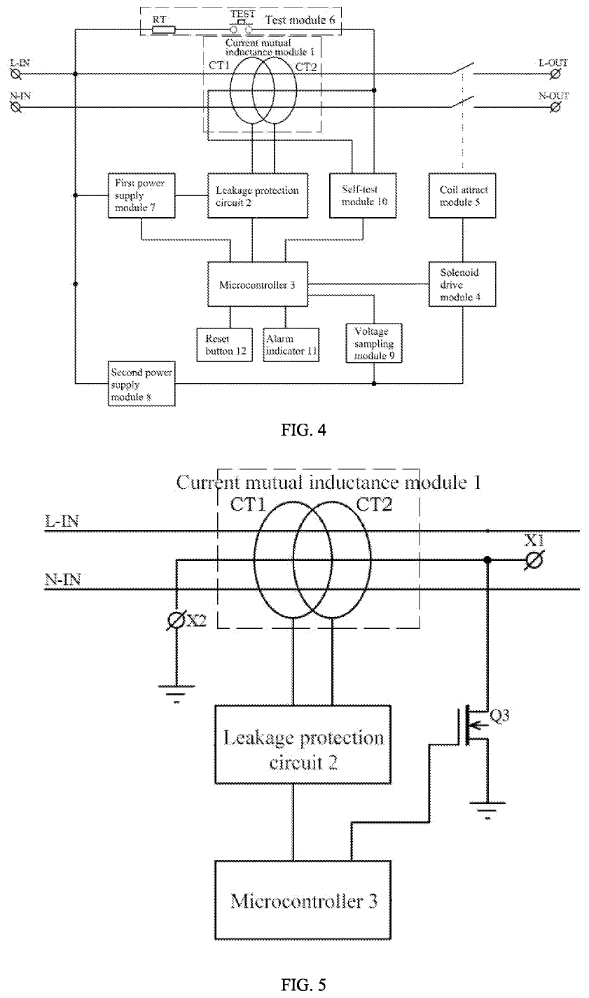

As shown in FIG. 4, in an embodiment, the test module 6 includes a variable resistor RT and a test switch TEST, where the variable resistor RT and the test switch TEST are arranged on a test line. When the test switch TEST is turned on, the test wires passing through the first current transformer CT1 and the second current transformer CT2 generates residual current, and the first current transformers CT1 and the second current transformer CT2 send the detected residual current to the leakage protection circuit 2, so that the residual current is compared with the preset residual current value through the comparison circuit inside the leakage protection circuit 2. If the residual current is greater than the preset residual current value, the leakage protection circuit 2 generates a leakage signal and sends the leakage signal to the microcontroller 3. The microcontroller 3 generates a trip signal according to the leakage signal, and sends the trip signal to the solenoid drive module 4, so that the solenoid drive module 4 controls the coil attract module 5 to trip according to the trip signal, thereby cutting off the circuit to be tested.

The leakage protection switch provided in the embodiment includes a current mutual inductance module 1, a leakage protection circuit 2, a microcontroller 3, a solenoid drive module 4, a coil attract module 5 and a test module 6, where an input end of the current mutual inductance module 1 is connected to the circuit to be tested, and an output end of the current mutual inductance module 1 is connected to an input end of the leakage protection circuit 2. The current mutual inductance module 1 is configured to detect the residual current signal of the circuit to be tested and send the residual current signal to the leakage protection circuit 2. An output end of the leakage protection circuit 2 is connected to the input end of the microcontroller 3, and the leakage protection circuit 2 is configured to receive the residual current signal and determine whether the residual current signal is greater than a set threshold. If yes, a leakage signal is generated and sent to the microcontroller 3. The output ends of the microcontroller 3 are connected to the input end of the solenoid drive module 4, and the microcontroller 3 is configured to generate a trip signal according to the leakage signal and send the trip signal to the solenoid drive module 4. An output end of the solenoid drive module 4 is connected to one end of the coil attract module 5, and the solenoid drive module 4 is configured to control the coil attract module 5 to trip according to the trip signal, to cut off the circuit to be tested. The solenoid drive module 4 includes a first drive submodule 41 and a second drive submodule 42. The first output end of the microcontroller 3 is connected to a control end of the first drive submodule 41, and the second output end of the microcontroller 3 is connected to a control end of the second drive submodule 42. An output end of the first drive submodule 41 and an output end of the second drive submodule 42 are both connected to the coil attract module 5. One end of the test module 6 is connected to the circuit to be tested, and the other end of the test module 6 is connected to the current mutual inductance module 1. The test module 6 is configured to test the leakage protection switch. By connecting the control ends of the first drive submodule 41 and second drive submodule 42 to the microcontroller 3, and connecting the output ends to the coil attract module 5, after the microcontroller 3 sends a trip signal, the two drive submodules control the action of the coil attract module 5, thereby reducing the probability of rejection and improving the reliability of the leakage protection switch control. Before the leakage protection switch officially works, the test module 6 generates the residual current to determine whether the leakage protection switch can trip normally. If the detection circuit is cut off, it is indicated that the leakage protection switch can trip normally, otherwise it is indicated that the leakage protection switch cannot trip normally. Therefore, whether the leakage protection switch can work normally can be tested, to provide users with a safe and reliable leakage protection function and realize all-round safety protection.

As shown in FIG. 4, in an embodiment, the leakage protection switch further includes a first power supply module 7, where an input end of the first power supply module 7 is connected to the circuit to be tested, and an output end of the first power supply module 7 is respectively connected to the leakage protection circuit 2 and the microcontroller 3. The first power supply module 7 is configured to supply power to the leakage protection circuit 2 and the microcontroller 3.

In an embodiment, the first power supply module 7 may adopt a circuit structure shown in FIG. 4, or may adopt other existing power circuits to supply power to the leakage protection circuit 2 and the microcontroller 3.

As shown in FIG. 4, in an embodiment, the leakage protection switch further includes a second power supply module 8, where an input end of the second power supply module 8 is connected to the circuit to be tested, and an output end of the second power supply module 8 is respectively connected to the solenoid drive module 4 and the coil attract module 5. The second power supply module 8 is configured to supply power to the solenoid drive module 4 and the coil attract module 5.

In an embodiment, the voltage of the second power supply module 8 is formed at both ends of the L phase line and the N phase line of the circuit to be tested by means of resistance-capacitance step-down and full-wave rectification, and then the solenoid K1 is supplied with power through the solenoid drive unit. As shown in FIG. 2, in an embodiment, the second power supply module 8 includes a second resistor R1, a second capacitor C1 and a rectifier D1, where one end of the second resistor R1 is connected to the L phase line of the circuit to be tested, and the other end of the second resistor R1 is connected to one end of the second capacitor C1. The other end of the second capacitor C1 is connected to a first end of the rectifier D1. A second end of the rectifier D1 outputs the power supply V1; a third end of the rectifier D1 is connected to the N phase of the circuit to be tested; and a fourth end of the rectifier D1 is connected to ground.

As shown in FIG. 4, in an embodiment, the leakage protection switch further includes a voltage sampling module 9, where an input end of the voltage sampling module 9 is connected to the second power supply module 8, and an output end is connected to the microcontroller 3. After the leakage protection switch is powered on, the solenoid drive module 4 is powered by the second power supply module 8, and then the power supply voltage signal of the second power supply module 8 is collected and sent to the microcontroller 3 by the voltage sampling module 9. The comparison circuit inside the microcontroller 3 compares the power supply voltage signal with the preset solenoid drive voltage value to determine whether the power supply voltage delivered by the second power supply module 8 to the solenoid drive module 4 reaches the preset solenoid drive voltage value. If the power supply voltage signal reaches the preset solenoid driving voltage value, a turn-on signal is sent to the solenoid drive module 4, and the solenoid drive module 4 drives the solenoid K1 to charge according to the turn-on signal to cut off the switch on the circuit to be tested. In the embodiment, the voltage sampling module 9 adopts an existing voltage sampling circuit. As shown in FIG. 4, in an embodiment, the leakage protection switch further includes a self-test module 10, where an input end of the self-test module 10 is connected to the microcontroller 3, and an output end of the self-test module 10 is connected to the current mutual inductance module 1.

As shown in FIG. 5, in an embodiment, the self-test module 10 includes a self-test switch Q3, where a control end of the self-test switch Q3 is connected to the output end of the microcontroller 3. A first end of the self-test switch Q3 is connected to the X1 end of the test line, and a second end of the self-test switch Q3 is connected to ground. The leakage protection switch starts to self-test within 3 seconds after the switch contact of the solenoid K1 is closed, and self-tests once every ten minutes. When the self-inspection time is reached, the microcontroller 3 sends a conduction signal to the control end of the self-test switch Q3, to trigger the conduction of the self-test switch Q3 and start the self-inspection process. When the self-test of the leakage protection switch fails, it is indicated that a component in the self-test circuit has failed. At this time, the microcontroller 3 sends a pulse signal to the alarm indicator 11 to make the alarm indicator 11 flash quickly, indicating the life of the leakage protection switch has been terminated, so that the staff is prompted to replace the leakage protection switch. When the self-test of the leakage protection switch is normal, the alarm indicator 11 is on for 0.5 seconds to remind the staff that the leakage protection switch has passed the self-test.

As shown in FIG. 4, in an embodiment, the leakage protection switch further includes an alarm indicator 11, where the alarm indicator 11 is connected to the microcontroller 3.

In an embodiment, when the leakage protection switch is in a trip action, the microcontroller 3 sends a pulse signal to the alarm indicator 11 to control the alarm indicator 11 to be always on.

As shown in FIG. 4, in an embodiment, the leakage protection switch further includes a reset button 12, where the reset button 12 is connected to the microcontroller 3.

In an embodiment, no matter the leakage protection switch is in any state, when the reset button 12 is pressed, the leakage protection switch immediately trips and disconnects, and the leakage protection switch self-tests and automatically sucks together after the reset button 12 is released. If the internal circuit of the leakage protection switch is faulty, the alarm indicator 11 flashes quickly after the self-test of the self-test module 10, and the leakage protection switch is not be turned off.

Obviously, the above-mentioned embodiments are merely illustrative of the disclosure, and are not intended to limit the disclosure. Any changes, modifications and replacements made by those of ordinary skill in the art without departing from the spirit of the disclosure still fall within the scope of the present disclosure.

What is claimed is:

1. A leakage protection switch, comprising:
a current mutual inductance module;
a leakage protection circuit;
a microcontroller;
a solenoid drive module;
a coil attract module; and
a test module;
wherein an input end of the current mutual inductance module is connected to a circuit to be tested; an output end of the current mutual inductance module is connected to an input end of the leakage protection circuit; the current mutual inductance module is configured to detect a residual current signal of the circuit to be tested, and send the residual current signal to the leakage protection circuit;
an output end of the leakage protection circuit is connected to an input end of the microcontroller; the leakage protection circuit is configured to receive the residual current signal and determine whether the residual current signal is greater than a set threshold; if the residual current signal is greater than the set threshold, a leakage signal is generated and sent to the microcontroller;
output ends of the microcontroller are connected to an input end of the solenoid drive module; the microcontroller is configured to generate a trip signal according to the leakage signal, and send the trip signal to the solenoid drive module; output ends of the solenoid drive module are connected to one end of the coil attract module; the solenoid drive module is configured to control the coil attract module to trip according to the trip signal, thereby cutting off the circuit to be tested; the solenoid drive module comprises a first drive submodule and a second drive submodule; the output ends of the microcontroller comprises a first output end and a second output end; the first output end of the microcontroller is connected to a control end of the first drive submodule; the second output end of the microcontroller is connected to a control end of the second drive submodule; an output end of the first drive submodule and an output end of the second drive submodule are both connected to the coil attract module;
one end of the test module is connected to the circuit to be tested, and the other end of the test is connected to the current mutual inductance module; and the test module is configured to test the leakage protection switch.

2. The leakage protection switch of claim 1, wherein the coil attract module comprises a solenoid and a first capacitor; one end of the solenoid is connected to an output end of the first drive submodule, and the other end of the solenoid is connected to one end of the first capacitor and the output end of the second drive submodule, and then connected to a first external power supply; and the other end of the first capacitor is connected to ground.

3. The leakage protection switch of claim 2, wherein the first drive submodule comprises a first controllable switch; a first end of the first controllable switch is connected to one end of the solenoid; a control end of the first controllable switch is connected to the first output end of the microcontroller; and a second end of the first controllable switch is connected to ground.

4. The leakage protection switch of claim 3, wherein the second drive submodule comprises a second controllable switch and a first resistor; a first end of the second controllable switch is connected to one end of the first resistor; a control end of the second controllable switch is connected to the second output end of the microcontroller; and a second end of the second controllable switch is connected to ground; and
the other end of the first resistor is respectively connected to the end of the first capacitor connected to the solenoid and the end of the solenoid connected to the first capacitor.

5. The leakage protection switch of claim 4, wherein the second drive submodule further comprises a third controllable switch and a second resistor;
wherein a first end of the third controllable switch is respectively connected to one end of the second resistor and the control end of the second controllable switch; a control end of the third controllable switch is connected to the second output end of the microcontroller; a second end of the third controllable switch is connected to ground; and
the other end of the second resistor is connected to a second external power supply.

6. The leakage protection switch of claim 1, further comprising:
a first power supply module;
wherein an input end of the first power supply module is connected to the circuit to be tested; an output end of the first power supply module is respectively connected to the leakage protection circuit and the microcontroller; and the first power supply module is configured to supply power to the leakage protection circuit and the microcontroller.

7. The leakage protection switch of claim 1, further comprising:
a second power supply module;
wherein an input end of the second power supply module is connected to the circuit to be tested; an output end of the second power supply module is respectively connected to the solenoid drive module and the coil attract module; and the second power supply module is configured to supply power to the solenoid drive module and the coil attract module.

8. The leakage protection switch of claim 7, further comprising:
a voltage sampling module;
wherein an input end of the voltage sampling module is connected to the second power supply module; an output end of the voltage sampling module is connected to the microcontroller; and the voltage sampling module is configured to collect a power supply voltage signal of the second power supply module.

9. The leakage protection switch of claim 1, further comprising:
a self-test module;
wherein an input end of the self-test module is connected to the microcontroller;
an output end of the self-test module is connected to the current mutual inductance module; and the self-test module is configured to self-test the leakage protection switch.

10. The leakage protection switch of claim 1, wherein the test module comprises a variable resistor and a test button, and the variable resistor is connected to the test button.

11. The leakage protection switch of claim 1, further comprising a reset button;
wherein the reset button is connected to the microcontroller, and the reset button is configured to reset the leakage protection switch.

12. The leakage protection switch of claim 1, further comprising:
an alarm indicator;
wherein the alarm indicator is connected to the microcontroller, and the alarm indicator is configured to work when a failure occurs to the leakage protection switch.
